(19) United States
(12) Patent Application Publication
(10) Pub. No.: US 2022/0416265 A1
(43) Pub. Date: Dec. 29, 2022

(54) FUEL CELL SYSTEM

(71) Applicant: UltraCell LLC, Livemore, CA (US)

(72) Inventors: Ru CHEN, Dublin, CA (US); John Ryan MURPHY, Tracy, CA (US); Robert P. CUENIN, Stockton, CA (US); Jonathan ABENA, Martinez, CA (US); Franklin P.T. BARCINAS, Stockton, CA (US); Ian W. KAYE, Livermore, CA (US); Jeffery D. BALDIC, Milford, MA (US)

(21) Appl. No.: 17/849,456

(22) Filed: Jun. 24, 2022

Related U.S. Application Data
(60) Provisional application No. 63/215,180, filed on Jun. 25, 2021.

(51) Int. Cl. H01M 8/04014

(52) U.S. Cl. CPC H01M 8/04014; H01M 2250/20

(57) ABSTRACT

A portable fuel cell system that is compact. The integration of a snorkel into the chassis allows the fuel cell to operate inside a backpack. The fuel cell system includes a thermal management system to keep the surface of the chassis at a comfortable temperature for the user. A boiler is mounted on a side of the fuel cell stack such that waste heat from the fuel cell stack is efficiently transferred to the boiler to vaporize fuel. A burner is positioned away from the fuel cell stack so that the system can be more compact. A thermal management system, including a blower, a heatsink, and a cooling air shroud, regulates the temperature of the fuel cell system.

### RELATED APPLICATIONS

This application claims the benefit of U.S. Provisional Application No. 63/215,180, filed on Jun. 25, 2021. The foregoing application is hereby incorporated by reference herein for all purposes.

### BACKGROUND OF THE INVENTION

The present disclosure generally relates to fuel cells. More specifically, the disclosure relates to portable fuel cell systems for reliably powering a variety of devices.

Fuel cells are electrochemical devices that can be used in a wide range of applications, including transportation, material handling, stationary, and portable power applications. Fuel cells use fuel and air to generate electricity by electrochemical reactions and release reaction byproducts as exhaust. For example, the byproducts generated by methanol fuel cells are water vapor and carbon dioxide. In addition to electricity, some energy in the fuels is released as heat. In some applications, fuel cells are used as a wearable, portable power source. Portable fuel cells should therefore be not only lightweight and compact, but they also need to have an air intake and exhaust outlet. The waste heat from fuel cells must be effectively dissipated through the exhaust outlet in order to maintain a reasonable contact temperature between the fuel cell system enclosure and the person who is wearing the fuel cell. It will be noted that the air delivery to and thermal management of fuel cells is very challenging when the fuel cells are used in relatively close environments, such as backpacks. Therefore, it would be desirable to be able to provide portable fuel cell systems that are lightweight, compact, and comfortable to wear.

### SUMMARY OF THE INVENTION

In accordance with an embodiment, a fuel cell system is provided. The fuel cell system includes a fuel cell stack, a boiler, and a burner. The boiler is mounted on a side of the fuel cell stack. The waste heat from the fuel cell stack is transferred to the boiler to vaporize fuel. The burner is positioned away from the fuel cell stack, and the burner provides heat to the fuel cell stack via a heat pipe.

In accordance with another embodiment, a thermal management system is provided for a fuel cell system. The thermal management system includes a chassis, an air gap positioned between the chassis and an engine block, a heatsink, a blower, and a cooling air shroud. The engine block includes a fuel processor and a fuel cell stack. The heatsink is attached to the fuel cell stack. The blower is configured to draw cooling air to the heatsink attached to the fuel cell stack.

In accordance with yet another embodiment, fuel cell system is provided. The fuel cell system includes a fuel cell stack, a boiler, a burner, and a chassis. The boiler is mounted on a side of the fuel cell stack. Waste heat from the fuel cell stack is transferred to the boiler to vaporize methanol, and the boiler comprises a heat pipe. The burner is positioned away from the fuel cell stack, and the burner provides heat to the fuel cell stack via a heat pipe. The chassis encloses the fuel cell stack, the boiler, and the burner.

### BRIEF DESCRIPTION OF THE DRAWINGS

The invention, together with further objects and advantages thereof, may best be understood by reference to the following description taken in conjunction with the accompanying drawings in which:

FIG. 1A is a perspective view of a fuel cell system and a snorkel in accordance with an embodiment.

FIG. 1B is a perspective view of the fuel cell system fitted in the snorkel shown in FIG. 1A.

FIG. 2 is a perspective view of a fuel cell system in accordance with another embodiment.

FIG. 3 is a perspective view of the fuel cell stack shown in FIG. 2 with the chassis cover removed.

FIG. 4 is a side cross-sectional view of the fuel cell stack shown in FIGS. 2 and 3.

FIG. 5 is a top view of the fuel cell system shown in FIGS. 2-4 with the chassis cover removed.

FIG. 6 is a cross-sectional perspective view of the fuel cell system shown in FIGS. 2-5.

FIG. 7 is a top view of the fuel cell system shown in FIGS. 2-6 without the chassis cover.

FIG. 8 shows gaskets between the chassis body and chassis cover in a fuel cell system according to an embodiment.

FIG. 9 shows a water-tight cover over an exhaust outlet in a fuel cell system according to an embodiment.

### DETAILED DESCRIPTION OF EMBODIMENTS

The present invention relates generally to fuel cell systems. Portable fuel cell systems can be placed in a backpack and worn by users to provide power to various electronic devices, such as radio and satellite communications gear, laptop computers, night vision goggles, and remote surveillance systems. Embodiments of fuel cell systems described herein can continue generate and provide power in remote locations at extreme temperatures. The fuel cell systems described herein are fueled by hydrogen-rich gases produced by reforming methanol. It will be understood that, in other embodiments, a fuel cell system can be fueled by other fuels, such as hydrogen.

According to embodiments described herein, the fuel cells can be polymer electrolyte membrane or proton exchange membrane (PEM) fuel cells having a membrane electrode assembly (MEA). In a PEM fuel cell fueled by hydrogen, the membrane allows hydrogen protons to transfer from an anode to a cathode with catalysts on both electrodes to assist in chemical reactions. Hydrogen is provided to the anode while oxygen is provided to the cathode. The hydrogen breaks down at the anode into electrons and protons, and the electrons pass through an electrical circuit connected to the membrane cell to provide electrical power while the protons pass through the membrane to the cathode. The electrons and protons combine with oxygen at the cathode to produce water vapor.

Bipolar plates are positioned between individual fuel cells to separate them and provide electrical connection between the cells. The bipolar plates also provide physical structure and allow the stacking of individual fuel cells into fuel cell stacks to provide higher voltages. In some embodiments, the fuel cell system is fueled by hydrogen-rich gases produced by reforming methanol, natural gas, or liquefied petroleum gas, etc. In other embodiments, the fuel cell system can be fueled by other fuels, such as hydrogen. It will be understood that any other types of fuel cells can be used in a fuel cell system, including solid acid fuel cells, solid oxide fuel cells, phosphoric acid fuel cells, molten carbonate fuel cells, and alkaline fuel cells.

Heat is generated when a fuel cell produces electricity. Thus, to maintain desired fuel cell operating temperatures, excess waste heat must be removed. The thermal management of a fuel cell can be conducted by a variety of methods, including air cooling or liquid cooling, depending on the power outputs and applications. Portable fuel cell systems capable of operating in extreme conditions are described herein. The fuel cell systems described herein are capable of operating at temperatures in the range of about 80° C.-240° C. and the thermal management of the fuel cell systems are conducted by air cooling. According to an embodiment, a suitable operating temperature of the fuel cell system 200 is 160° C.-240° C. According to another embodiment, a suitable operating temperature of the fuel cell system 200 is about 160° C.-200° C.

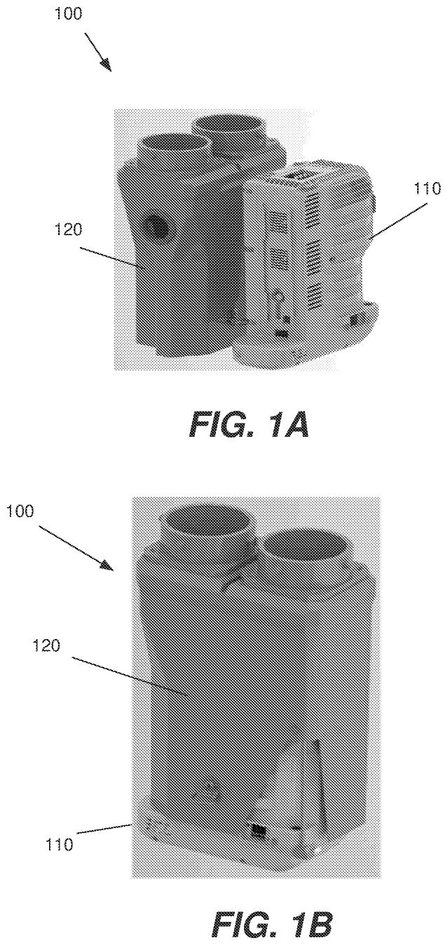

The surface of portable fuel cell systems should be maintained at a comfortable temperature for users. Insulating layers can be used to cover the fuel cell system to maintain a comfortable surface temperature of the system. The traditional approach is to apply many layers of insulation material until the surface temperature is acceptable. A fuel cell system 100 having a fuel cell chassis 110 in a removable snorkel 120 is shown in FIGS. 1A and 1B. A snorkel is a fuel cell enclosure that can be used to reduce the surface temperature of the fuel cell system 100 so that the fuel cell system 100 can be comfortably worn by a user. The fuel cell chassis 110 is shown next to a snorkel 120 in FIG. 1A. In FIG. 1B, the fuel cell chassis 110 is shown in the snorkel 120. Air is supplied to the fuel cell through an intake fan. The fuel cell exhaust is then removed from the fuel cell via an exhaust fan. Air circulates in a gap between the fuel cell 100 and the snorkel 120 to reduce the surface temperature of the snorkel 120, which is formed of a flexible plastic or composite material.

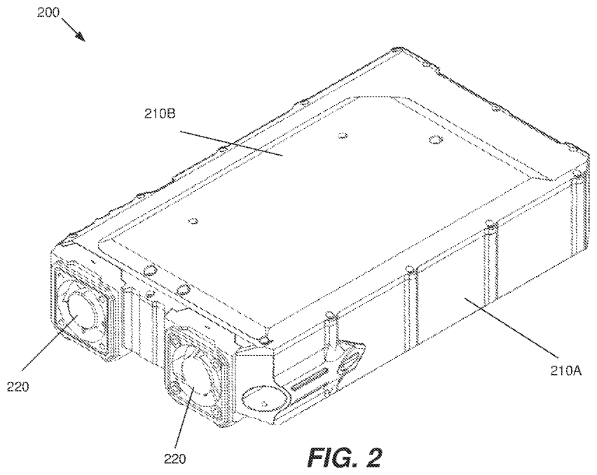

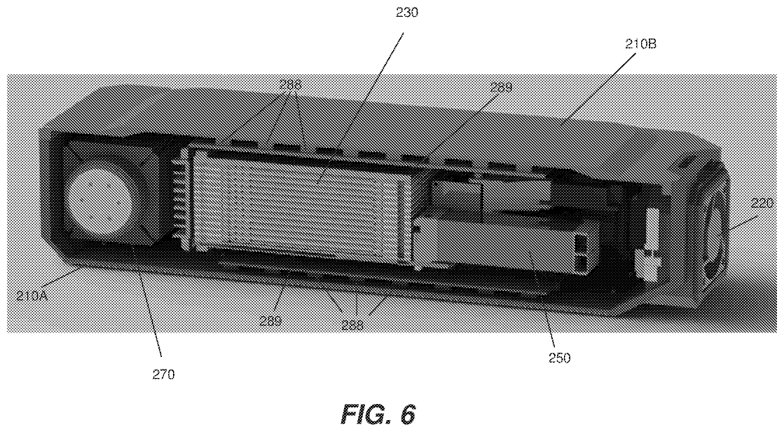

According to an embodiment of a fuel cell system 200, the snorkel and fuel cell chassis are integrated into a single integral device, as shown in FIG. 2. According to this integrated embodiment, the snorkel is integrated into the chassis 210A, 210B of the fuel cell, and is an inseparable part of the fuel cell system 200. An air intake fan 220 and an exhaust fan 222 are integrated into the chassis and an air gap (as described in more detail below) to facilitate air flow). Integrating the snorkel into the chassis 210 reduces the weight and volume of the fuel cell system 200, as it reduces the need for multiple layers of thick insulation. In the illustrated embodiment, the chassis includes a chassis body 210A and a chassis cover 210B. The chassis includes protrusions that create an air gap for internal active air cooling, as explained in more detail below and as shown in FIG. 6. According to an embodiment, both the chassis body 210A and the chassis cover 210B can be 3D printed. In other embodiments, the chassis body 210A and chassis cover 210 can be formed by injection molding or compression molding.

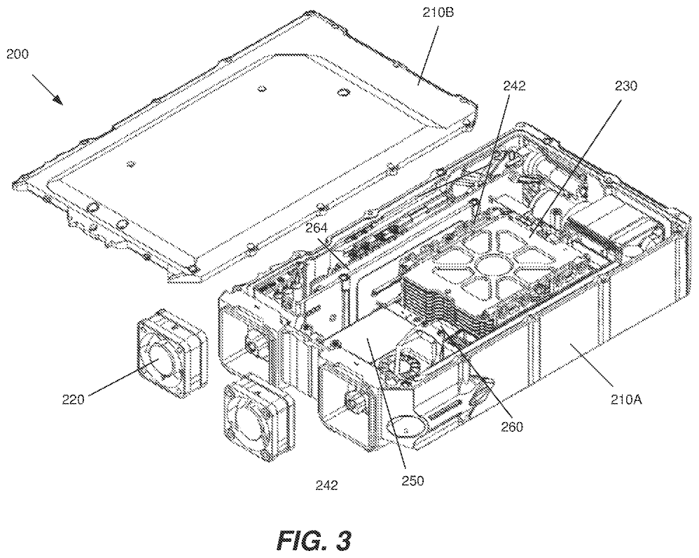

As noted above, a portable, wearable fuel cell system 200 should be compact in addition to being maintained at a comfortable operating temperature. To make the fuel cell system 200 as compact as possible, the layout of the components in the fuel cell system 200 should be carefully designed. FIG. 3 is a partially exploded perspective view of the fuel cell system 200 with the chassis cover 210B removed from the chassis body 210A. The cooling fans 220 are also shown removed from their positions in the chassis body 210A. FIG. 3 shows the other components of the fuel cell system 200 as they are positioned within the chassis body 210A.

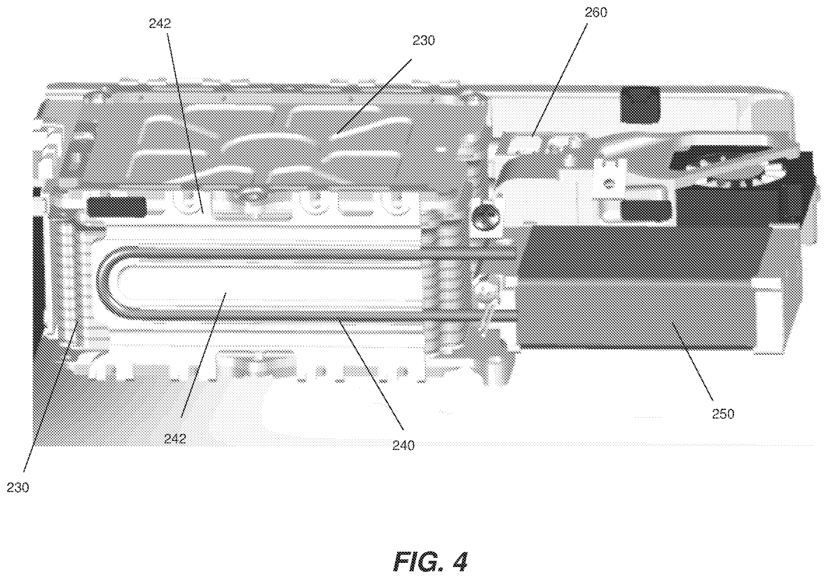

A burner 260 provides heat to a fuel cell stack 230 by burning methanol fuel during the startup phase of the fuel cell operation. Typically, a stack burner is mounted onto the fuel cell stack to provide heat directly to the fuel cell stack. However, in embodiments described herein, the fuel cell stack 230 is positioned spaced-apart from the burner 260 at different locations within the chassis body 210A to efficiently utilize the space inside the fuel cell system 200, as shown in FIGS. 3 and 4. In these embodiments, heat pipes are used to transfer heat from the burner 260 to the fuel cell stack 230. A heat pipe is a fully passive, self-contained heat transfer device that combines the thermal conductivity and phase transition to effectively transfer heat between two solid interfaces. In this case, the heat pipe transfers heat from the burner 260 to the fuel cell stack 230. Copper/water heat pipes have effective thermal conductivities from 100,000 to 200,000 W/mK, which is hundreds of times higher than that of aluminum and copper.

Another benefit of positioning the burner 260 away from fuel cell stack 230 is that a more even temperature is maintained for the fuel cell stack 230. Unlike a burner that is mounted onto the fuel cell stack, a separate burner 260, such as the one in the illustrated embodiment, does not create hot spots that might be too hot for and damage the fuel cell stack 230.

As shown in FIG. 3, the fuel cell stack 230 is positioned within the chassis body 210A near a printed circuit board (PCB) 264 for controlling the fuel cell system 200. As shown in FIG. 3, the fuel cell stack 230 is positioned adjacent an external boiler 240 to recover some waste heat from the fuel cell stack 230. In the embodiment shown in FIG. 3, an external boiler 240 is mounted on a side of the fuel cell stack 230. As shown in FIG. 4, the boiler 240 is fitted into a correspondingly shaped groove in a boiler block 242, which is mounted on a side of the fuel cell stack 230.

Waste heat that is generated by the fuel cell stack 230 during operation can be efficiently used to vaporize methanol in the adjacent boiler 240. The use by the boiler 240 of the waste heat reduces the surface temperature of the fuel cell system 200. As noted above, a reduced surface temperature allows the fuel cell system 200 to be worn more comfortably by a user. Methanol fuel is vaporized in the boiler 240 by waste heat from the fuel cell stack 230 before it enters the fuel processor 250 (or reformer) where the methanol is then converted into hydrogen gas for use in the fuel cell stack 230. By mounting the boiler 240 on the fuel cell stack 230, waste heat from the fuel cell stack 230 that would otherwise need to be removed from the system 200 is used by the boiler 240 and therefore reduced, thereby lowering the burden of the thermal management subsystem, and increasing the system efficiency.

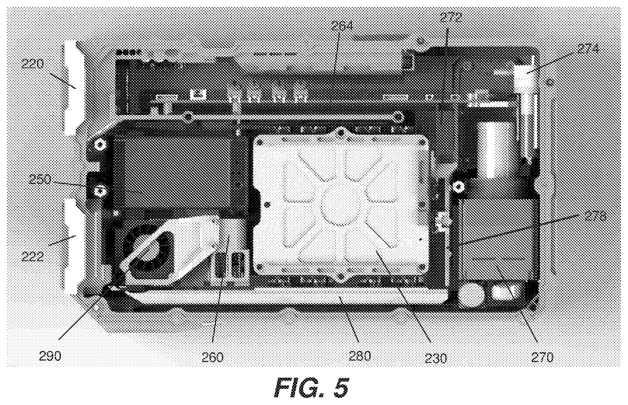

According to an embodiment, the boiler 240 is a tube boiler with a wick layer on the inner wall of the tube. The wick materials in the wick layer can be sintered powder, screen/mesh, or groove extrusions. In the illustrated embodiment, the boiler 240 is a commercial off-the-shelf U-shaped heat pipe with its end-caps cut off. As shown in FIG. 4, the heat pipe is fitted in a groove in an aluminum boiler block 242 that is mounted on a side of the fuel cell stack 230. It will be understood that waste heat from the fuel cell stack 230 is transferred to the boiler block 242. Heat from the boiler block 242 is then transferred to the boiler 240. The boiler block 242 has a greater surface area than the boiler 240. Thus, the boiler block 242 allows more heat to be transferred from the fuel cell stack 230 than just the boiler 240 alone. As the boiler 240 is fitted into the boiler block 242, more of the surface area of the boiler 240 can be exposed to, and therefore receive heat from, the boiler block 242. As shown in FIG. 5, a compressor 270 provides air to the cathode of the fuel cell stack 230 and a pump 274 supplies fuel (e.g., methanol) to the fuel processor or reformer 250.

In addition to the positioning of components within the chassis as described above, a thermal management system can be used to control the temperature of the fuel cell system 200. According to an embodiment, the thermal management system includes an air gap, a blower 272, a cooling air shroud 280, and another blower 290 for removing exhaust heat from the fuel cell system 200.

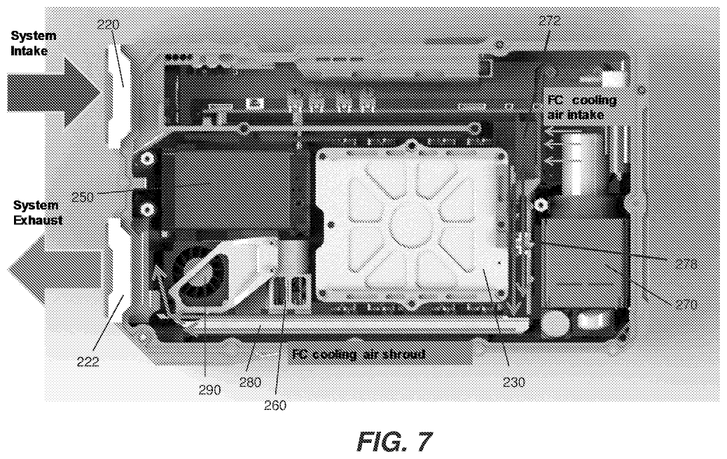

To further reduce the surface temperature of the fuel cell system 200, an air gap is positioned between the engine block (i.e., fuel cell stack 230 and fuel processor 250 assembly) and the chassis, as shown in FIGS. 5-7. The air gap is created by protrusions 288 that extend inward from the inner surface of the bottom of the chassis body 210A to support a flat plate 289 and protrusions 288 that extend inward from the inner or bottom surface of the chassis cover 210B to support a flat plate 289. It will be understood that the air gap is the space between the flat plates 289 and the chassis (chassis body 210A and chassis top 210B). The air gap provides a cooling air flow path through the fuel cell system 200. As shown in FIG. 6, the protrusions 288 support the flat plate 289 and space apart the flat plate from the chassis to create the air gap for airflow. Ambient air is drawn into the fuel cell system 200 through the air intake fan 220. It will be understood that the ambient air is typically cooler than the temperature within the fuel cell system 200 when the system 200 is operating. As shown in the top view of FIG. 7, a blower 272 draws in cool air from the intake and pushes it through a heatsink 278 that is attached to the fuel cell stack 230. The warm air from the fuel cell stack 230 is forced to flow through a fuel cell cooling air shroud 280, as shown by arrows in FIG. 7.

As the air flows past the fuel cell stack 230, it warms and flows toward a cooling air shroud 280. The cooling air shroud 280 routes the warm air toward the exit of the fuel cell system 200. As shown in FIG. 7, a blower 290 directs the warm air flow through an exhaust fan 222 to exit the fuel cell system 200.

It will be understood that the air gap should be large enough to enable a low enough pressure drop with adequate air flow to provide cooling air for the fuel cell system 200 with a small, quiet blower 272. Conversely, the air gap cannot be sized too large because the fuel cell system 200 is a portable system, so it should be as compact as possible. According to an embodiment, the height of the air gap is in a range of about 0.5 mm to about 5 mm. As will be appreciated, the height of the air gap is about the same as the height of the protrusions.

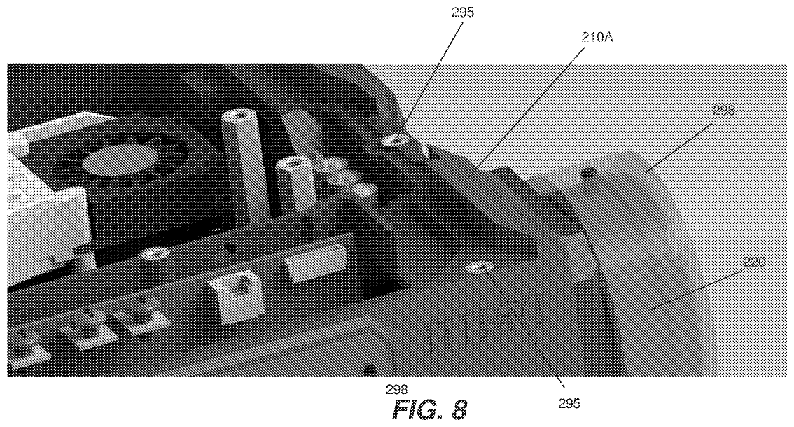

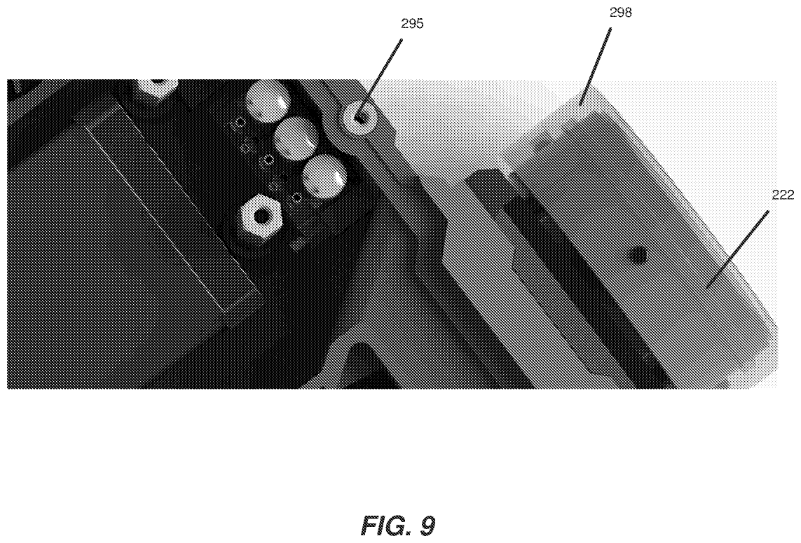

According to an embodiment, the fuel cell system 200 is designed to be waterproof when it is immersed in water. Gaskets are used between the chassis body 210A and the chassis cover 210B, as shown in FIG. 8 to form a water-tight seal between the chassis body 210A and the chassis cover 210B. Caps with O-rings 298 are used to cover the air intake 220 and exhaust outlet 222 when the fuel cell is not in operation, as shown in FIGS. 8 and 9. According to some embodiments, the fuel cell system 200 is waterproof up to a depth of about one meter in water.

In view of all of the foregoing, it should be apparent that the present embodiments are illustrative and not restrictive and the invention is not limited to the details given herein, but may be modified within the scope and equivalents of the appended claims.

What is claimed is:

1. A fuel cell system, comprising:
a fuel cell stack;
a boiler mounted on a side of the fuel cell stack, wherein waste heat from the fuel cell stack is transferred to the boiler to vaporize fuel; and
a burner positioned away from the fuel cell stack, wherein the burner provides heat to the fuel cell stack via a heat pipe.

2. The fuel cell system as recited in claim 1, wherein the boiler comprises a heat pipe.

3. The fuel cell system as recited in claim 2, further comprising a chassis enclosing the fuel cell stack, the boiler, and the burner, wherein the chassis is configured with an air gap for facilitating air flow through the fuel cell system.

4. The fuel cell system as recited in claim 1, further comprising a thermal management system configured to regulate a temperature of the fuel cell system.

5. The fuel cell system as recited in claim 4, wherein the thermal management system comprises a blower, a heatsink, and a cooling air shroud.

6. The fuel cell system as recited in claim 5, wherein the thermal management system further comprises a second blower for removing exhaust heat from the fuel cell system.

7. The fuel cell system as recited in claim 3, wherein the chassis includes a plurality of protrusions and flat plates that form an air gap for air flow, wherein some of the protrusions extend inward from a top surface to support a flat plate and some of the protrusions extend inward from a bottom surface of the chassis, and wherein the air gap is formed in a space between the chassis and an engine block, wherein the engine block comprises the fuel cell stack and a fuel processor.

8. The fuel cell system as recited in claim 7, wherein the air gap has a height of at least about 0.5 mm and less than about 5 mm.

9. The fuel cell system as recited in claim 1, further comprising an intake exhaust fan configured to draw ambient air into the fuel cell system.

10. The fuel cell system as recited in claim 1, wherein the fuel cell stack is a polymer electrolyte membrane fuel cell stack having a membrane electrode assembly.

11. The fuel cell system as recited in claim 5, wherein the cooling air shroud is positioned near the fuel cell stack to direct warm air to an exit of the fuel cell system.

12. The fuel cell system as recited in claim 1, wherein the fuel cell system is waterproof up to a depth of about one meter in water.

13. A thermal management system for a fuel cell system, the thermal management system comprising:
a chassis;
an air gap positioned between the chassis and an engine block, wherein the engine block comprises a fuel processor and a fuel cell stack;
a heatsink attached to the fuel cell stack;
a first blower configured to draw cooling air to the heatsink attached to the fuel cell stack; and
a cooling air shroud.

14. The thermal management system as recited in claim 13, wherein the air gap provides a cooling air flow path through the fuel cell system.

15. The thermal management system as recited in claim 13, wherein the air gap is formed between a flat plate and the chassis, wherein the flat plate is supported by a plurality of protrusions that extend inward from an inner surface of the chassis.

16. The thermal management system as recited in claim 13, wherein the first blower pushes the cooling air through the heatsink.

17. The thermal management system as recited in claim 13, wherein the cooling air shroud routes warm air toward an exit of the fuel cell system.

18. The thermal management system as recited in claim 19, wherein a second blower directs warm air through the exit.

19. A fuel cell system, comprising:
a fuel cell stack;
a boiler mounted on a side of the fuel cell stack, wherein waste heat from the fuel cell stack is transferred to the boiler to vaporize methanol, and wherein the boiler comprises a heat pipe;
a burner positioned away from the fuel cell stack, wherein the burner provides heat to the fuel cell stack via a heat pipe; and
a chassis enclosing the fuel cell stack, the boiler, and the burner.

20. The fuel cell system as recited in claim 1, further comprising a thermal management system configured to regulate a temperature of the fuel cell system, wherein the thermal management system comprises a blower, a heatsink, and a cooling air shroud.
